(19) United States
(12) Patent Application Publication
(10) Pub. No.: US 2017/0123991 A1
(43) Pub. Date: May 4, 2017

(54) SYSTEM AND METHOD FOR UTILIZATION OF A DATA BUFFER IN A STORAGE DEVICE

(71) Applicant: SanDisk Technologies Inc., Plano, TX (US)

(72) Inventors: Rotem Sela, Haifa (IL); Miki Sapir, Nes Ziona (IL); Amir Shaharabany, Kochav Yair (IL); Hadas Oshinsky, Kfar Saba (IL); Alon Marcu, Tel Mond (IL); Nir Perry, Hod Hasharon (IL)

(73) Assignee: SanDisk Technologies Inc., Plano, TX (US)

(21) Appl. No.: 14/925,334

(22) Filed: Oct. 28, 2015

(51) Int. Cl. G06F 12/08

(52) U.S. Cl. CPC G06F 12/0868; G06F 2212/1016; G06F 2212/202; G06F 2212/281; G06F 2212/313

(57) ABSTRACT

Systems and methods for managing a data buffer of a non-volatile memory system are disclosed. The method may include a controller of a storage system retrieving host data, storing the retrieved data in a data buffer and transferring the data to a non-volatile memory. The controller may then overwrite the retrieved data in the data buffer as soon as the retrieved data has been transferred to the non-volatile memory die but prior to sending a command to program that data to the non-volatile memory array of the non-volatile memory. The system includes a non-volatile memory with a plurality of data latches and a non-volatile memory array, a data buffer and a controller configured to free the data buffer for receiving new data as soon as the prior data is transferred to the data latches and prior to any indication on success of programming prior data to the non-volatile memory array.

### BACKGROUND

Non-volatile memory systems, such as flash memory, are used in digital computing systems as a means to store data and have been widely adopted for use in consumer products. Non-volatile memory systems may be found in different forms, for example in the form of a portable memory card that can be carried between host devices or as embedded memory in a host device. In write operations between a host device and a non-volatile memory system, a certain amount of time is necessary to transfer data from a host to a buffer in the non-volatile memory system, and then from the buffer to the non-volatile memory cells. The longer write operations take, the greater potential that an abrupt power down of the non-volatile memory system may happen during a write operation and potentially cause a write failure.

Host data is typically stored at a relatively small data buffer, for example static random access memory (SRAM), in the controller of the non-volatile memory system. If a write failure occurs when writing from the data buffer to non-volatile memory such as flash memory, the controller may perform a write retry operation using a copy of the data, which is stored at the data buffer. Generally, a copy of the data is stored at the controller data buffer and is released only after verification that the data is stored successfully in the flash memory. The data buffer in the controller, however, can be an expensive resource in terms of consumption of space and power, and its size is typically small which may make it a bottleneck for host write operations.

### BRIEF DESCRIPTION OF THE DRAWINGS

FIG. 1A is a block diagram of an example non-volatile memory system.

FIG. 1B is a block diagram illustrating an exemplary storage module.

FIG. 1C is a block diagram illustrating a hierarchical storage system.

FIG. 2A is a block diagram illustrating exemplary components of a host and a controller of a non-volatile memory system.

FIG. 2B is a block diagram illustrating exemplary components of a non-volatile memory of a non-volatile memory storage system.

FIG. 3 illustrates an alternative embodiment of the host of FIG. 2A.

FIG. 4 is a block diagram illustrating a host, a non-volatile memory system and an external memory device.

FIG. 5 is a block diagram illustrating a host data buffer with data for each host command divided into multiple chunks.

FIG. 6 is a flow chart illustrating an embodiment of a method executable on the non-volatile memory system to manage usage of the data buffer in non-volatile memory system.

FIG. 7 is a flow chart illustrating an alternative embodiment of the method of FIG. 6.

### DETAILED DESCRIPTION

A non-volatile memory system is described herein that can utilize its internal data buffer to buffer incoming host data and transfer that data to non-volatile memory in the non-volatile memory system in a manner that may permit faster data throughput than traditional non-volatile memory systems. The non-volatile memory system may release its volatile memory buffer as soon as it has transferred data to the non-volatile memory, rather than waiting for confirmation that the write operation has been successful. New data may overwrite the prior data in the data buffer of the non-volatile memory before any program verification from the non-volatile memory cells (e.g. NAND memory cells) or error checking of the prior data written from the data buffer to non-volatile memory. Although the examples below generally discuss a host write command and the utilization of a non-volatile memory system data buffer for a host write command, the systems and methods described herein may be applied to any of a number of types of host commands.

In one implementation, a data storage system may include a non-volatile memory, having a plurality of data latches and a non-volatile memory array, and a volatile memory with a data buffer. A controller may have, or be cooperatively coupled with, the volatile memory and be in communication with the non-volatile memory. The controller may be configured to request, from a host in communication with the data storage system, first data associated with a pending host command and to write the first data to the data buffer in the volatile memory. The controller may copy the first data from the data buffer to the plurality of data latches in the non-volatile memory. Prior to verification that the first data retrieved from the plurality of latches was successfully written to the non-volatile memory array in the non-volatile memory, the controller may request additional data from the host and overwrite at least some of the first data in the data buffer with the additional data such that the verifying lags behind the overwriting.

In a different implementation, a data storage system includes a non-volatile memory, having a plurality of data latches and a non-volatile memory array, as well as a data buffer and a controller in communication with the non-volatile memory and the data buffer. The controller is configured to request, from a host in communication with the data storage system, first data associated with a pending host command. In response to receiving the first data from the host, the controller is configured to write the first data to the data buffer in the data storage system, retrieve the first data from the data buffer and transfer it to the plurality of data latches. The controller is configured to then release the data buffer after writing the first data to the non-volatile memory, but prior to receiving any write verification from the non-volatile memory regarding the success of writing the data from the data latches to non-volatile memory cells in the non-volatile memory array.

In another implementation, a method of managing data in a data storage system in communication is disclosed. The method includes the data storage system requesting, from a memory in communication with the data storage system, first data associated with a pending host command. In response to receiving the first data from the memory, the data storage system may write the first data to a data buffer in volatile memory in the data storage system. The data storage system may then continue by requesting the first data from the data buffer and transferring the first data retrieved from the data buffer to data latches in a non-volatile memory in the data storage system. Subsequently, the method continues by releasing the data buffer after transferring the first data to the data latches in the non-volatile memory and prior to receiving any write verification from the non-volatile memory regarding a successful programming of the first data to a non-volatile memory array in the non-volatile memory.

In different implementations, requesting the first data from the memory may be requesting the first data from a host data buffer on the host or requesting the first data from an external data buffer in a location other than on the host or the data storage system. Releasing the data buffer may include updating a data buffer management table in the data storage system to reflect that there is no valid data in the data buffer. Also the method may include, in response to receiving an indication of a write failure relating to the first data, determining from the data buffer management table whether the first data is valid in the data buffer and, when the first data is determined to be valid in the data buffer, retrying a write of the first data from the data buffer into the non-volatile memory. Alternatively, when the data buffer does not contain valid first data, the method may include re-requesting the first data from the memory and, upon receipt of the re-requested first data at the data buffer, writing the first data from the data buffer to the non-volatile memory. The method may include receiving an indication of a voltage detection error at the data storage system as the indication of a write failure, or may include receiving an indication of an error correction failure as the indication of write failure.

According to another implementation, a method of managing data in a data storage system in communication with a host is disclosed. The method may include the storage system requesting data associated with a pending host command from a memory outside of the data storage system, storing the data in a data buffer in the data storage system, retrieving the data from the data buffer and writing the data retrieved from the data buffer to non-volatile memory in the data storage system. The method also includes prior to verification that the data retrieved from the data buffer in the data storage system was successfully written to the non-volatile memory, retrieving additional data from the host and overwriting at least some the data in the data buffer with the additional data. In different implementations the memory outside of the data storage system comprises a host data buffer on the host or a data buffer positioned in a memory in a location other than the data storage system or the host.

According to yet another implementation, a non-transitory computer readable medium is disclosed. The non-transitory computer readable medium may include instructions for causing a controller of a data storage system to request, from a memory in communication with the data storage system, first data associated with a pending host command. The instructions may further include instructions to, in response to receiving the first data from the memory, cause the controller to write the first data to a data buffer in the data storage system and then retrieve the first data from the data buffer and transfer the first data to data latches in a non-volatile memory of the storage system. The computer readable medium may further include instructions to cause the controller to retrieve additional data from the memory and overwrite the first data in the data buffer prior to executing a program command to program the first data from the data latches into a non-volatile memory array in the non-volatile memory.

Other embodiments and implementations are possible, and each of the embodiments and implementations can be used alone or together in combination. Accordingly, various embodiments and implementations will be described with reference to the attached drawings.

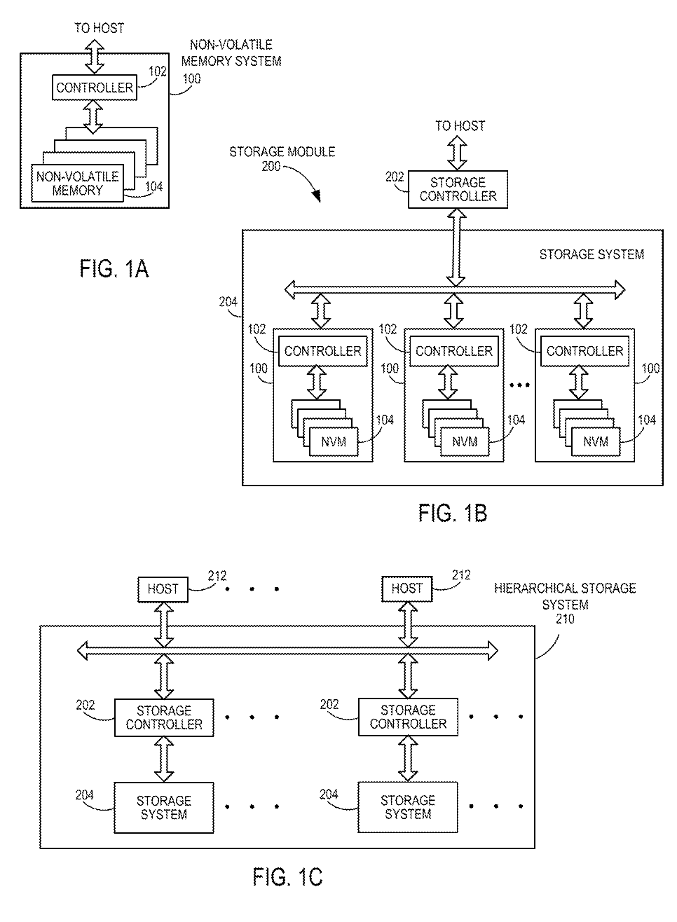

FIG. 1A is a block diagram illustrating a non-volatile memory system. The non-volatile memory (NVM) system 100 (also referred to herein as a storage system) includes a controller 102 and non-volatile memory that may be made up of one or more non-volatile memory die 104. As used herein, the term die refers to the set of non-volatile memory cells, and associated circuitry for managing the physical operation of those non-volatile memory cells, that are formed on a single semiconductor substrate. Controller 102 interfaces with a host system and transmits command sequences for read, program, and erase operations to non-volatile memory die 104.

The controller 102 (which may be a flash memory controller) can take the form of processing circuitry, a microprocessor or processor, and a computer-readable medium that stores computer-readable program code (e.g., software or firmware) executable by the (micro)processor, logic gates, switches, an application specific integrated circuit (ASIC), a programmable logic controller, and an embedded microcontroller, for example. The controller 102 can be configured with hardware and/or firmware to perform the various functions described below and shown in the flow diagrams. Also, some of the components shown as being internal to the controller can also be stored external to the controller, and other components can be used. Additionally, the phrase “operatively in communication with” could mean directly in communication with or indirectly (wired or wireless) in communication with through one or more components, which may or may not be shown or described herein.

As used herein, a flash memory controller is a device that manages data stored on flash memory and communicates with a host, such as a computer or electronic device. A flash memory controller can have various functionality in addition to the specific functionality described herein. For example, the flash memory controller can format the flash memory to ensure the memory is operating properly, map out bad flash memory cells, and allocate spare cells to be substituted for future failed cells. Some part of the spare cells can be used to hold firmware to operate the flash memory controller and implement other features. In operation, when a host needs to read data from or write data to the flash memory, it will communicate with the flash memory controller. If the host provides a logical address to which data is to be read/written, the flash memory controller can convert the logical address received from the host to a physical address in the flash memory. (Alternatively, the host can provide the physical address). The flash memory controller can also perform various memory management functions, such as, but not limited to, wear leveling (distributing writes to avoid wearing out specific blocks of memory that would otherwise be repeatedly written to) and garbage collection (after a block is full, moving only the valid pages of data to a new block, so the full block can be erased and reused).

Non-volatile memory die 104 may include any suitable non-volatile storage medium, including NAND flash memory cells and/or NOR flash memory cells. The memory cells can take the form of solid-state (e.g., flash) memory cells and can be one-time programmable, few-time programmable, or many-time programmable. The memory cells can also be single-level cells (SLC), multiple-level cells (MLC), triple-level cells (TLC), or use other memory cell level technologies, now known or later developed. Also, the memory cells can be fabricated in a two-dimensional or three-dimensional fashion.

The interface between controller 102 and non-volatile memory die 104 may be any suitable flash interface, such as Toggle Mode 200, 400, or 800. In one embodiment, NVM system 100 may be a card based system, such as a secure digital (SD) or a micro secure digital (micro-SD) card. In an alternate embodiment, memory system 100 may be part of an embedded memory system.

Although in the example illustrated in FIG. 1A, NVM system 100 includes a single channel between controller 102 and non-volatile memory die 104, the subject matter described herein is not limited to having a single memory channel. For example, in some NAND memory system architectures, such as in FIGS. 1B and 1C, 2, 4, 8 or more NAND channels may exist between the controller and the NAND memory device, depending on controller capabilities. In any of the embodiments described herein, more than a single channel may exist between the controller and the memory die, even if a single channel is shown in the drawings.

FIG. 1B illustrates a storage module 200 that includes plural non-volatile memory (NVM) systems 100. As such, storage module 200 may include a storage controller 202 that interfaces with a host and with storage system 204, which includes a plurality of NVM systems 100. The interface between storage controller 202 and NVM systems 100 may be a bus interface, such as a serial advanced technology attachment (SATA) or peripheral component interface express (PCIe) interface. Storage module 200, in one embodiment, may be a solid state drive (SSD), such as found in portable computing devices, such as laptop computers, and tablet computers.

FIG. 1C is a block diagram illustrating a hierarchical storage system. A hierarchical storage system 210 includes a plurality of storage controllers 202, each of which control a respective storage system 204. Host systems 212 may access memories within the hierarchical storage system via a bus interface. In one embodiment, the bus interface may be a non-volatile memory express (NVMe) or a fiber channel over Ethernet (FCoE) interface. In one embodiment, the system illustrated in FIG. 1C may be a rack mountable mass storage system that is accessible by multiple host computers, such as would be found in a data center or other location where mass storage is needed.

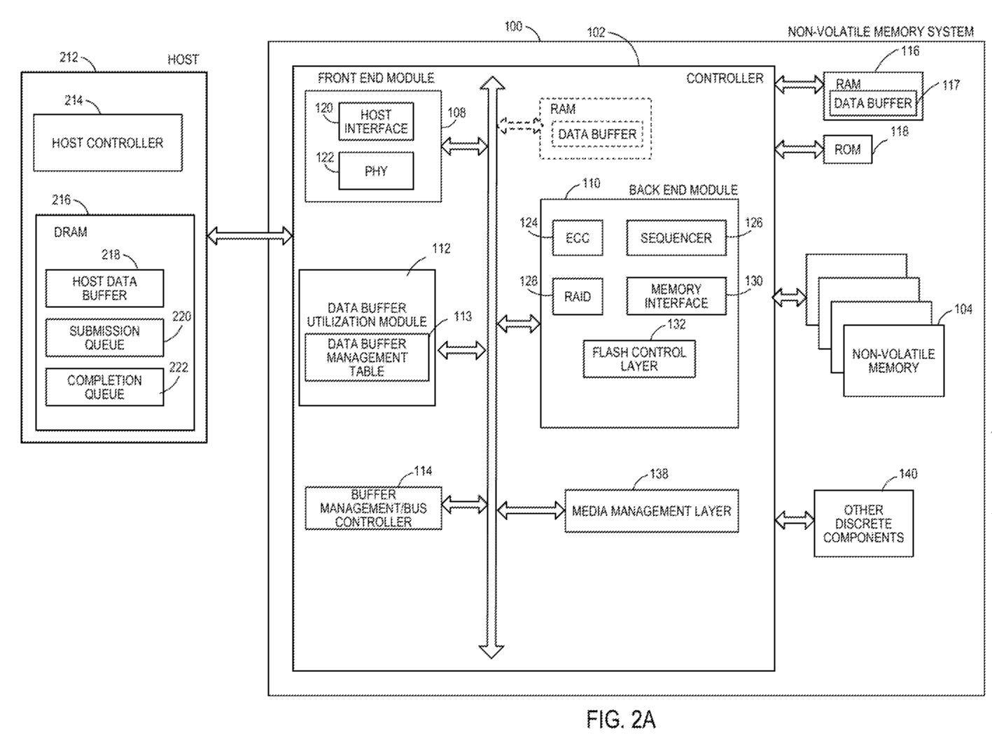

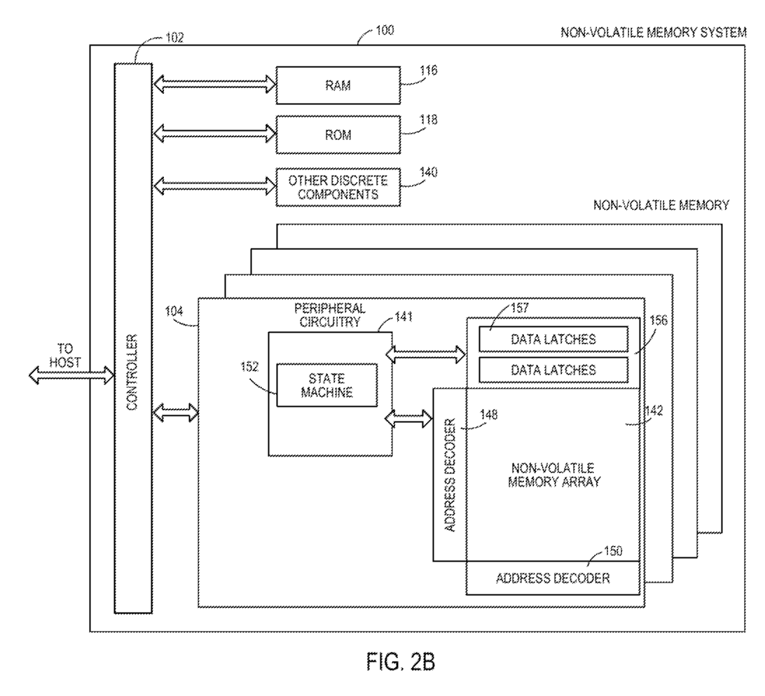

FIG. 2A is a block diagram illustrating a host 212 and a NVM system 100 communicating via a host interface 120. In one implementation, the host 212 and NVM system 100 may be configured as NVMe devices and the interface 120 may be a PCIe interface. These particular formats and interfaces are only noted by way of example and any of a number of other formats and interfaces are contemplated such as NVMe and UFS. FIG. 2A also illustrates exemplary components of controller 102 in more detail. Controller 102 includes a front end module 108 that interfaces with a host, a back end module 110 that interfaces with the one or more non-volatile memory die 104, and various other modules that perform functions which will now be described in detail.

A module may take the form of a packaged functional hardware unit designed for use with other components, a portion of a program code (e.g., software or firmware) executable by a (micro)processor or processing circuitry that usually performs a particular function of related functions, or a self-contained hardware or software component that interfaces with a larger system, for example.

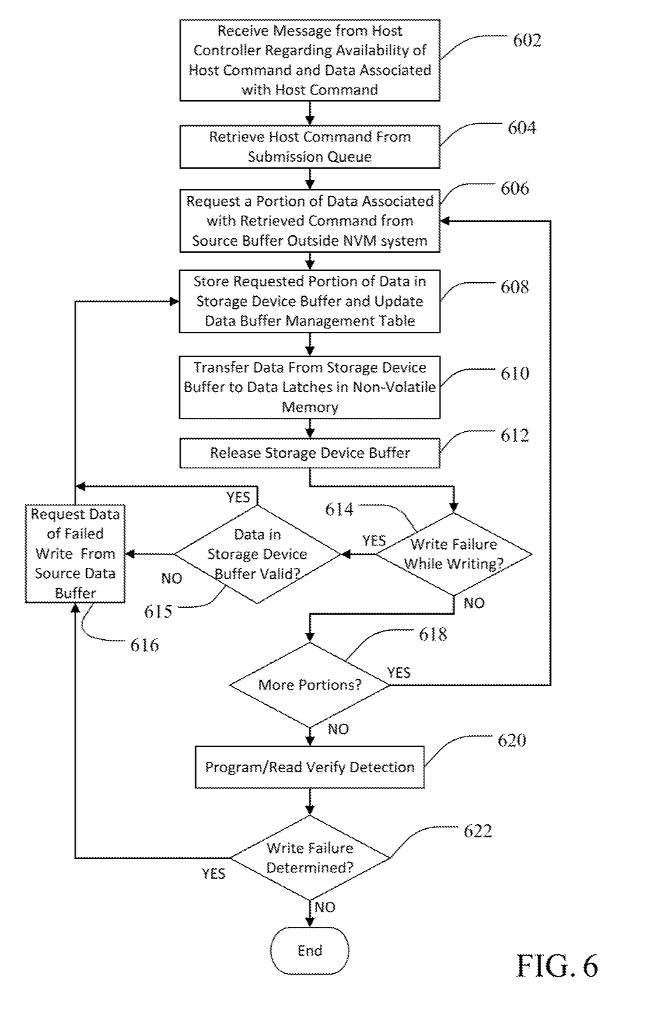

Modules of the controller 102 may include a data buffer utilization module 112 present on the die of the controller 102. As explained in more detail below in conjunction with FIG. 6, the data buffer utilization module 112 is arranged to write data from an internal data buffer 117 in the NVM system 100 into non-volatile memory 104 in the NVM system 100, and then release the local data buffer 117 to receive more data from the host 212 or other storage device prior to receiving a verification of a successful write of the earlier data from the local data buffer 117 into the non-volatile memory 104.

The release of the data buffer may be accomplished by the data buffer utilization module 112 updating a data buffer management table 113 to reflect that there is no valid data in the local data buffer 117 so that more data may be received. The data buffer utilization module may then overwrite the data in the buffer with new data from the host or other source. The data buffer management table 113 may be in the data buffer utilization module 112 or stored elsewhere in memory in the NVM system 100. Upon detection of a write error relating to data written from the local data buffer 117 to the non-volatile memory 104, the data buffer utilization module may re-try the data write by retrieving the data from the host or other source, storing it again in the local data buffer 117 and re-writing the data from the buffer 117 to the non-volatile memory. Although many of the examples below describe host write commands, the data buffer management techniques below may apply to any of a number of types of host command that is associated with data that is transferred to the NVM system 100 for processing.

Referring again to modules of the controller 102, a buffer manager/bus controller 114 manages other buffers in random access memory (RAM) 116 and controls the internal bus arbitration of controller 102. A read only memory (ROM) 118 stores system boot code. Although illustrated in FIG. 2A as located separately from the controller 102, one or both of the RAM 116 and ROM 118 may be located within the controller 102. The local data buffer 117 for storing portions of data associated with a host command may be located in the RAM 116 of the NVM system 100. In yet other embodiments, portions of RAM and ROM may be located both within the controller 102 and outside the controller. Further, in some implementations, the controller 102, RAM 116, and ROM 118 may be located on separate semiconductor die. RAM 116 may be any of a number of types of RAM, such as static RAM (SRAM) or dynamic RAM (DRAM).

Front end module 108 includes a host interface 120 and a physical layer interface (PHY) 122 that provide the electrical interface with the host or next level storage controller. The choice of the type of host interface 120 can depend on the type of memory being used. Examples of host interfaces 120 include, but are not limited to, SATA, SATA Express, SAS, Fibre Channel, USB, PCIe, UFS and NVMe. The host interface 120 typically facilitates transfer for data, control signals, and timing signals.

Back end module 110 includes an error correction controller (ECC) engine 124 that encodes the data bytes received from the host, and decodes and error corrects the data bytes read from the non-volatile memory. A command sequencer 126 generates command sequences, such as program and erase command sequences, to be transmitted to non-volatile memory die 104. A RAID (Redundant Array of Independent Drives) module 128 manages generation of RAID parity and recovery of failed data. The RAID parity may be used as an additional level of integrity protection for the data being written into the non-volatile memory system 100. In some cases, the RAID module 128 may be a part of the ECC engine 124. A memory interface 130 provides the command sequences to non-volatile memory die 104 and receives status information from non-volatile memory die 104. In one embodiment, memory interface 130 may be a double data rate (DDR) interface, such as a Toggle Mode 200, 400, or 800 interface. A flash control layer 132 controls the overall operation of back end module 110.

Additional components of system 100 illustrated in FIG. 2A include media management layer 138, which performs wear leveling of memory cells of non-volatile memory die 104. System 100 also includes other discrete components 140, such as external electrical interfaces, external RAM, resistors, capacitors, or other components that may interface with controller 102.

In alternative embodiments, one or more of the physical layer interface 122, RAID module 128, media management layer 138 and buffer management/bus controller 114 are optional components that are not necessary in the controller 102.

FIG. 2A also illustrates aspects of a host 212 that the NVM system 100 may communicate with, manipulate and/or optimize. The host 212 includes a host controller 214 and volatile memory such as dynamic RAM (DRAM) 216. The host DRAM 216 may include a host data buffer 218, a command submission queue 220, a completion queue 222, and the shadow buffer 217. The host 212 may be configured to store user data in the host data buffer 218 and the commands associated with that user data in the command submission queue 220. The shadow buffer 217 is a portion of the DRAM 216 on the host 212 that is allocated for the exclusive use of the NVM system 100 and may be controlled via the data buffer utilization module 112 of the controller 102.

As shown in FIG. 2A, a buffer 117 may be located in volatile memory in the storage system 100, such as in RAM 116 that may inside or outside the controller 102. The buffer 117 may be used as the intermediate destination for chunks of data to be written to non-volatile memory on non-volatile memory die 104 or to be written to the shadow buffer 217 on the host. The shadow buffer 217, as described in greater detail below, is NVM system 100 space that may be used as storage space for chunks of data associated with a host command.

FIG. 2B is a block diagram illustrating exemplary components of non-volatile memory die 104 in more detail. Non-volatile memory die 104 includes peripheral circuitry 141 and non-volatile memory array 142. Non-volatile memory array 142 includes the non-volatile memory cells used to store data. The non-volatile memory cells may be any suitable non-volatile memory cells, including NAND flash memory cells and/or NOR flash memory cells in a two dimensional and/or three dimensional configuration. Non-volatile memory die 104 further includes a data cache 156 that caches data being read from or programmed into the non-volatile memory cells of the non-volatile memory array 142. The data cache 156 comprises sets of data latches 157 for each bit of data in a memory page of the non-volatile memory array 142. Thus, each set of data latches 157 may be a page in width and a plurality of sets of data latches 157 may be included in the data cache 156. For example, for a non-volatile memory array 142 arranged to store n bits per page, each set of data latches 157 may include n data latches where each data latch can store 1 bit of data.

In one implementation, an individual data latch may be a circuit that has two stable states and can store 1 bit of data, such as a set/reset, or SR, latch constructed from NAND gates. The data latches 157 may function as a type of volatile memory that only retains data while powered on. Any of a number of known types of data latch circuits may be used for the data latches in each set of data latches 157. Each non-volatile memory die 104 may have its own sets of data latches 157 and a non-volatile memory array 142. Peripheral circuitry 141 includes a state machine 152 that provides status information to controller 102. Peripheral circuitry 141 may also include additional input/output circuitry that may be used by the controller 102 to transfer data to and from the latches 157, as well as an array of sense modules operating in parallel to sense the current in each non-volatile memory cell of a page of memory cells in the non-volatile memory array 142. Each sense module may include a sense amplifier to detect whether a conduction current of a memory cell in communication with a respective sense module is above or below a reference level.

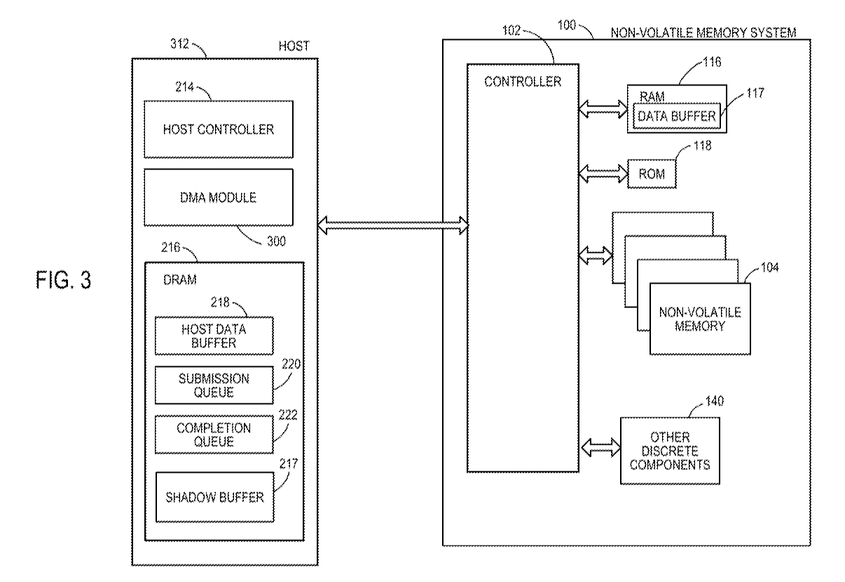

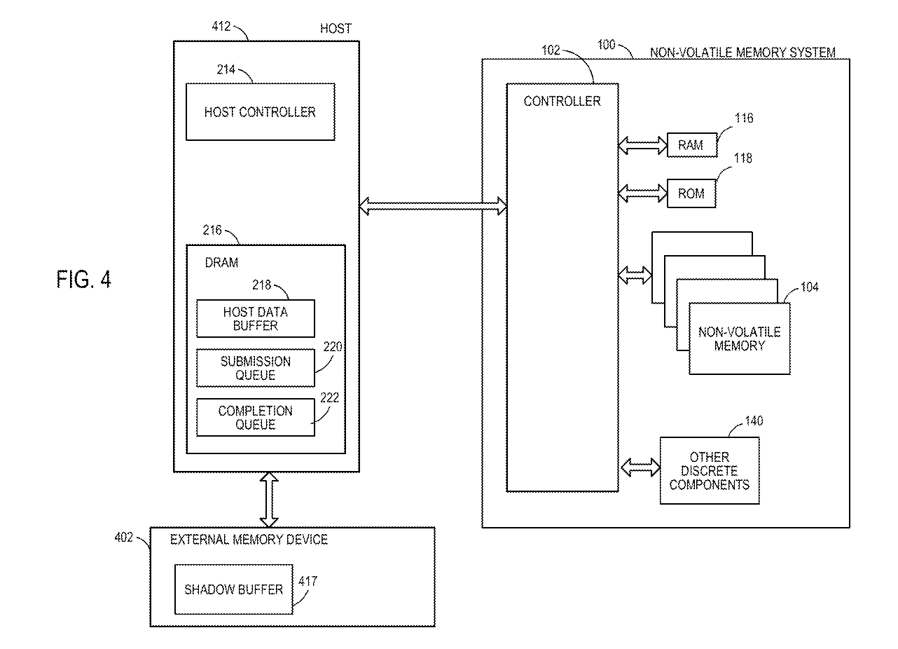

Alternate implementations of the host and NVM system are illustrated in FIGS. 3-4. In FIG. 3, the host 312 includes many of the same components as illustrated in FIG. 2A and the NVM system 100 has been simplified for clarity. The host 312 in FIG. 3 differs from that of FIG. 2A in that a direct memory access module 300 is included that allows the partial command completion module 112 of controller 102 of the non-volatile memory system 100 to transfer data directly from the host data buffer 218 to the shadow buffer 217 on the host 312. The DMA module 300 thus allows the controller 102 to skip the step of first copying data from the host data buffer 218 to the local data buffer 117 in RAM 116 in the NVM system 100 and then copying the data from the data buffer to the shadow buffer 217 on the host as is the case in the host configuration of FIG. 2A. In FIG. 4, a version of the shadow buffer 417 is shown on an external memory device 402 in communication with the host 412. In the implementation of FIG. 4, the shadow buffer 417 may be exclusively on the external memory device 402, or may be combined with a shadow buffer 217 on the host 212 (FIG. 2A).

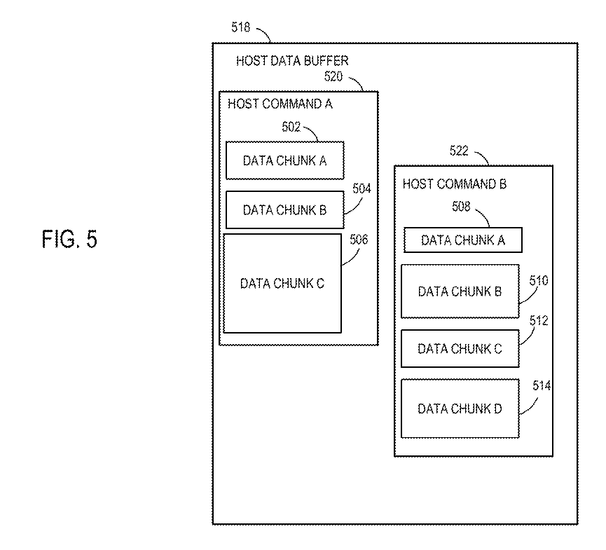

Referring to FIG. 5, an example of the host data buffer 518 is shown containing data for host commands. In this example, the data for host command A 520 is shown as made up of three separable data chunks of different sizes: data chunk A 502, data chunk B 504 and data chunk C 506. The data for host command B 522 is shown as made up of four data chunks, data chunk A 508, data chunk B 510, data chunk C 512 and data chunk D 514. The data chunks may be of different sizes and, as discussed below, each chunk may be separately retrieved and stored by the NVM system 100, and a partial write completion message generated individually for each chunk prior to all chunks for a particular host command being written.

The data chunks may be of any size and the size may be a multiple of a page size managed in the non-volatile memory die 104 in one implementation. A data chunk is a subset or portion of the total amount of data associated with a given write command, where each chunk consists of a contiguous run of logically addressed data. Additionally, the NVM system 100 may retrieve only part of a chunk of data. Thus, a host command associated with only a single chunk of data may be further broken up by the NVM system 100. The chunk size may be set by the NVM system 100 in a fixed, predetermined manner based on the size of the buffers in RAM in the NVM system, the program sequence, the non-volatile memory (e.g. flash) page size, or any of a number of other parameters in different implementations.

Referring to FIG. 6, a method of managing data writes using a data buffer acceleration technique is described. When a host controller 214 receives a write command, it may place the command in a submission queue 220 on the host 212, store the data associated with the write command in the host data buffer 218, and transmit to the NVM system 100 a message indicating that a command is in the queue 220. The NVM system 100 may receive a message from the host controller 214 that a host command is in the submission queue 220 (at 602). The controller 102 of the NVM system 100 may then retrieve the host command (at 604) and then retrieve a portion of the data associated with the host command from a source data buffer outside of the NVM system 100 (at 606). In different embodiments, the source data buffer may be the host data buffer 218 or a shadow buffer 217 on the host 212, or it may be a shadow buffer 417 on an external memory device 402.

The portion of data referred to above may be the entirety of the data for the host command, or it may be a subset of the entire data set for a command, such as a chunk of the data (for example, data chunk 502 of the entire data 520 associated with a particular host command). In one implementation, the entry in the submission queue 220 includes a pointer to the location of the associated data in the host data buffer 218. The controller 102 of the NVM system 100 may then store the portion of host data for the host command in buffer memory, such as in RAM 116 inside or outside of the controller 102 and update the data buffer management table 113 on the location of the data (at 608). The data buffer utilization module 112 may then transfer the portion of data to the non-volatile memory die 104 (at 610). In one embodiment, transferring the portion of data consists of transferring the portion of data from the local data buffer 117 to the data latches 157 on the non-volatile memory die 104 but not yet sending a programming command, or programming the data, to the non-volatile memory array 142. At this point, an acknowledgement may be provided from the non-volatile memory die 104 to the controller 102 that the transfer has been made to the data latches 157.

In one embodiment, the transfer of data from the data buffer to the non-volatile memory 104 may be postponed until the local data buffer 117 receives an amount of data that completely fills the local data buffer 117 or receives enough data to satisfy a predetermined threshold amount of data. Accordingly, if the total amount of data associated with a command is insufficient to meet the predetermined threshold amount, data associated with another host command may be aggregated in the local data buffer with the earlier data until that predetermined threshold is reached.

As soon as the portion of data is transferred to the non-volatile memory die 104 from the local data buffer 117, and before a command from the controller 102 is sent to program the portion of data from the latches to the non-volatile memory array 142 in the non-volatile memory 104 die, new data may be written into the local data buffer 117 overwriting some or all of the data that has just been transferred to the non-volatile memory die 104. In one embodiment, the non-volatile memory 104 may acknowledge to the controller 102 that the data has been received in the data latches 157 so that the controller knows it has finished transferring data from the local data buffer 117 to the data latches 157 of the non-volatile memory 104. In one embodiment, the data buffer utilization module 112 may release the local data buffer 117 as soon as the data has been transferred to the data latches 157 so that new data may be retrieved and overwrite the locations in the local data buffer 117 previously occupied by the just-written data (at 612). In one implementation, the data buffer utilization module 112 of the controller 102 releases the local data buffer 117 by updating the data buffer management table 113 to reflect that the data buffer no longer contains valid data. Accordingly, the data buffer utilization module 112 may direct new portions of data relating to the same or another host command to overwrite the local data buffer 117 as soon as the prior data in the buffer is transferred to the non-volatile memory die 104 (e.g. to the data latches 157 on the memory die 104 but not yet to the non-volatile memory cells of the non-volatile memory array 142 on the memory die 104) but prior to receipt of any confirmation or verification of a successful write of the prior data to the non-volatile memory array 142 (at 618). The controller 102 may receive a verification from non-volatile memory die 104 that the data transfer to the data latches 157 is complete prior to beginning overwriting the local data buffer 117 with additional data, but no verification of successful programming to the non-volatile memory array 142 is received prior to beginning the overwriting of the local data buffer 117. In one embodiment, the controller 102 may release the local data buffer 117, and permit overwriting of the data in the local data buffer 117 with new data, prior to sending a program command to the non-volatile memory die 104 to program the memory cells of the non-volatile memory array 142 with the data that was transferred to the data latches 157.

If there is a write failure that occurs while the data is being transferred from the local data buffer 117 to the non-volatile memory 104, for example a voltage detection error (VDET) where there has been a power fluctuation or failure while the data was being written from the buffer 117 to the data latches 157 in the non-volatile memory die 142 or while data is being programmed from the data latches 157 to the non-volatile memory array 142, the data buffer utilization module 112 may re-try the data write (at 614). In one implementation, the data buffer utilization module 112 may first check the data buffer management table 113 when a voltage detection error has occurred to see if the data in the local data buffer 117 is valid (at 615). If the data has not yet been overwritten and is thus valid, then the re-write of that data may be made directly from the local data buffer 117 rather than needing to return to the source data buffer outside of the NVM system 100. If the write failure is detected after some or all of the data in the local data buffer 117 has already been overwritten (at 614, 615), then the data may be requested by again retrieving the data for the failed write from the source buffer outside of the NVM system 100, for example the host data buffer 218 or a shadow buffer 217, 417 (at 616). The steps of transferring the retrieved data portion, updating the data buffer management table 113, transferring the data from the local data buffer 117 to non-volatile memory 104 and releasing the local data buffer 117 may then be repeated (at 608, 610 and 612). In one implementation, the data buffer management table 113 maintains information on the location of the data in the source data buffer (e.g. host data buffer 218) where the NVM system 100 needs to look to re-request the data, and the data buffer utilization module 112 looks up the desired address from that table 113.

As described above, if there is more data for the same command remaining, or if the prior command is completed and more data for another command is pending, then the data buffer utilization module 112 may immediately write more data to the local data buffer 117 and thus overwrite the storage locations in the local data buffer 117 with newly retrieved data from the appropriate source data buffer (at 618, 606). Subsequent to retrieval of more data, the data buffer utilization module 112 may detect program and/or read verify status of the data written to the non-volatile memory 104 (at 620). Thus, the detection of a programming verification or read verification for data transferred to a non-volatile memory die 104 lags behind the overwriting of data in the local data buffer 117 such that the overwriting of the local data buffer 117 is asynchronous with the verification of a successful write of the prior data to the non-volatile memory array 14. The detection of the program verify status may be via a standard non-volatile memory programming verification message, such as a NAND flash memory verification message automatically generated in NAND flash when a successful write has occurred that confirms there was no error in the flash memory programming steps. Alternatively, or in combination with the NAND verification, the data buffer utilization module 112 may utilize a different/second verification process to verify that the data does not have a second possible type of error. Data that is programmed successfully to NAND flash non-volatile memory in the non-volatile memory array 142, and therefore receives a positive NAND verification response indicating no error was noted in the typical flash programming routine, may still suffer from other types of errors due to programming of other data to a same memory cell (in the case of NAND flash memory cells storing 2 or 3 bits per cell) or to an adjacent memory cell. NAND non-volatile memory cells are described by way of example and non-volatile memory arrays 142 with other types of non-volatile memory cells may be utilized in other implementations.

These other types of write errors may be detected in a read verify operation carried out by the ECC circuitry 124. For example, an error correction code implemented by the ECC circuitry 124 in the NVM system 100 may be checked for the data as a way of verifying that the data was written correctly. In one implementation, a failure of a read verify operation is the detection of an uncorrectable ECC error, sometimes referred to an UECC error, that is beyond the ability of the ECC module 124 of the NVM system 100 to correct. Another type of error detection scheme, in addition to or separate from the NAND verification regarding errors in the program routine used to program the data into the non-volatile memory array 142 or the ECC check of the accuracy of the data, that may be implemented by the controller is a second level of error correction that can be applied after writing data to other memory cells adjacent to the memory cells containing the data that is being checked. This second level of error detection may be accomplished by use of an exclusive OR (XOR) function on the multiple sets of data and determining if an unexpected result is received. Any of number of error detection schemes relating to the verification of success of programming of the data into the memory cells of the non-volatile memory array may be used to determine if a read or programming failure has occurred that will require the process to retrieve data from source buffer and re-try programming of that data. As noted above, the controller 102 accelerates the use of the local data buffer 117 by freeing the buffer or overwriting some or all of the prior data in the buffer prior to verification of the success or failure of writing data to memory cells in the non-volatile memory array using any of the read or program verification methods noted above.

In situations where a program or read verification check, such the NAND verification or the ECC verification procedures noted above, indicates an error or other corruption, then the data buffer utilization module 112 may go back to the source data buffer and retrieve that data again and retry the partial write (at 622, 616). The detection of a write failure may, in some instances, not only affect the data of a particular host command, but may also affect multiple other host commands, such that the data for all non-verified (program or write verify of data programmed to the non-volatile memory array 142) commands may be retrieved again from the source data buffer (e.g. host data buffer 218 in DRAM 216). It should be noted that the sources of write failures to the non-volatile memory die 104 detected in FIG. 6 may include, but are not limited to, a voltage detection event (VDET), an abrupt power shut down, a program verify failure and a read verify failure.

Referring again to FIGS. 3-4, a source data buffer from which the NVM system 100 may request data, or in the case of a write failure re-request data for writing into the local data buffer 117 of the NVM system 100 may include the host data buffer 218 or a shadow buffer 217, 417. The shadow buffer 217, 417 may be used to take advantage of the greater volatile memory resources, such as DRAM 218, on the host than on the NVM system 100. According to one embodiment, when utilizing a shadow buffer 217, 417, the data for a given host command may be requested by the NVM system 100, written to the local data buffer 117 on the NVM system 100 and then written to the shadow buffer 217, 417, before later being written to the local data buffer 117 and then to non-volatile memory 104 on the NVM system.

Alternatively, in a host 312 having a direct memory access (DMA) module 300 and a shadow buffer 217, such as described for the example host 312 in FIG. 3, the need to first copy from host buffer 218 to local data buffer 117 may be avoided. In host embodiments with a DMA module 300, after receiving a message from the host 312 that a host command is available for execution in the submission queue 220, the NVM system 100 may retrieve the host command from the submission queue 220 and identify the location of the associated data for that command in the host data buffer 218. The NVM system 100 may then send instructions to the DMA module 300 on the host 312 to locate and move data associated with the host write command directly from the host data buffer 218 to the shadow buffer 217 without first copying the data from the host data buffer 218 to the local data buffer 117 in RAM 116, and then separately copying that chunk from the local data buffer 117 on the NVM system 100 to the shadow buffer 217 on the host 312 as would be the case if the host 312 did not have a DMA module 300.

The data management table 113 in the data buffer utilization module 112 may be updated to reflect the current status of data written to the shadow buffer 217. The data management table 113 may include the logical block address (LBA) range (e.g. LBAx to LBAy, where x and y refer to start and end LBA addresses for a contiguous string of LBA addresses) and the associated address range in the shadow buffer 217, 417 where that LBA range is currently stored. A command completion message may be sent from the controller 102 in the NVM system 100 to the host 312 after all data has been written for a given command. The command completion message may include command identification and/or data identification information placed in the completion queue 222 of the host by the NVM system 100, as well as an interrupt sent to notify host controller 214 to check the completion queue 222.

In one implementation, the NVM system 100 may be configured to operate with hosts 212 of different functional capabilities. In order to maintain the backwards compatibility with legacy hosts lacking the shadow buffer, a handshake message may be sent from the host 212 to the NVM system 100 at power-up identifying functional capabilities and shadow buffer information. For example, in one embodiment, the host controller 214 may be configured to send at power-up or at first connection of the NVM system 100 to the host 212, a configuration message that includes the addresses of all buffers or queues in the host (e.g., host data buffer address, shadow buffer address, and submission, completion and other queue addresses). The controller 102 of the NVM system 100 is configured to recognize the configuration message. Additionally, the host 212 may send the NVM system 100 addresses and formats for interrupts the host 212 needs to receive in order to use any special functionality. The NVM system 100 may recognize the handshake message and/or configuration message to identify the capabilities of the host, or the absence of such messages to identify legacy only capability. When the handshake and/or configuration message sent by the host 212 at power up indicates shadow buffer capabilities, the controller 102 may adjust its operation to utilize that additional host resource.

As has been described above, the local data buffer 117 of the NVM system 100 is allowed to accept additional data prior to confirmation or verification that the prior data in the data buffer has been successfully written to the non-volatile memory array 142 in non-volatile memory 104. The controller 102 may overwrite the prior data in the data buffer and/or release the data buffer prior to any read or write verification regarding the successful programming of data from the data buffer into the memory cells of the non-volatile memory array 142. The controller may also release and/or overwrite the local data buffer 117 prior to sending a program command to program the data most recently transferred from the local data buffer 117 to the data latches 157. Although the local data buffer 117 in the NVM system 100 is freed and overwritten before a verification of a successful write to the non-volatile memory array 142, and there is the possibility of errors in the data transfer or other programming errors that are later discovered using one or more program or read verification methods, data may still be re-requested from the source buffer on the host, for example.

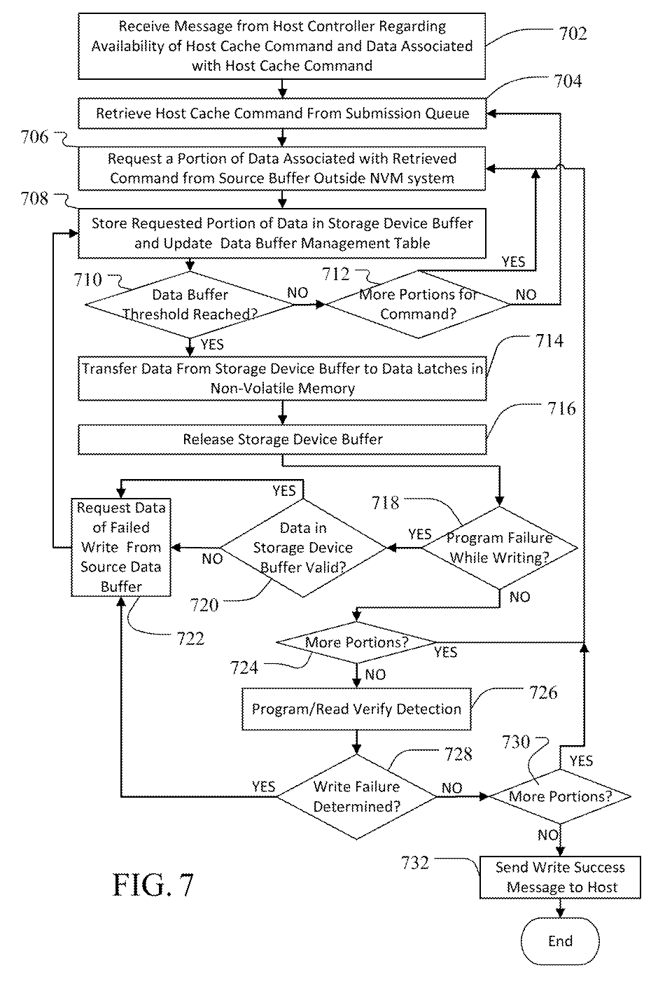

Referring now to FIG. 7, another method for managing the local data buffer 117 is described. In the method illustrated in FIG. 7, the data buffer utilization module 112 of the controller 102 is configured to handle a host cache command in a manner that allows the local data buffer 117 to release and/or be overwritten after writing data to the latches 157 in the non-volatile memory 104, but prevents the host from releasing or overwriting data in the host buffer 218 until the data is actually written into the non-volatile memory array 142 from the data latches 157. A host cache command may be a command that allows the NVM system 100 to decide whether to place data associated with the host cache command into the local buffer 117 or into the non-volatile memory array 142 of the NVM system 100. Typically, when data associated with a host cache command is stored in the local data buffer, the controller 102 would send the host a write success message that allows the host to release its own buffer 218 so that the data may be overwritten. In the method of FIG. 7, the controller delays sending a write success message to the host until all the data associated with the host cache command is actually successfully written to the non-volatile memory array.

In the embodiment of FIG. 7, the host controller sends a message indicating the availability of the host cache command in the command queue on the host (at 702). The NVM system 100 retrieves the host cache command and then requests data associated with that retrieved host cache command (at 704, 706). The controller 102 then stores the requested data in the local data buffer 117 (at 710). The local data buffer 117 may have a predetermined threshold amount that needs to be present in the buffer 117 before the buffer can transfer the data to the non-volatile memory 104. The threshold may be any predetermined amount, for example a page or a whole number multiple number of pages of data managed by the non-volatile memory array 142. The controller 102 checks to see if the local data buffer 117 has enough data to meet the threshold and, if so, transfers the data from the local data buffer to the data latches 157 in non-volatile memory (at 710, 714).

If the amount of data in the local data buffer 117 is less than the predetermined threshold amount, then the controller looks to add additional data to the local data buffer before writing to the non-volatile memory (at 712). The controller 102 may first look to see if there is more data for the same host cache command and, if so, retrieve and store that additional data in the local data buffer (at 712, 706, 708). If there is no more data left for the host cache command, then data for a next command in the command queue may be retrieved and stored in the data buffer with the data from the earlier command (at 712, 704, 706, 708). In either instance, once the amount of data in the local data buffer 117 satisfies the predetermined threshold, it is written to the data latches 157 (at 714).

In the same manner as discussed with reference to FIG. 6, the controller may then release the local data buffer and overwrite the prior data in the local data buffer with new data from the host data buffer 218 once a confirmation is received from the data latches 157, but before programming of the data from the data latches to the non-volatile memory array is started and/or complete, that the transfer to the data latches was successful. If there is a write failure that occurs while the data is being transferred from the local data buffer 117 to the non-volatile memory 104, for example a voltage detection error (VDET) where there has been a power fluctuation or failure while the data was being written from the buffer 117 to the data latches 157 in the non-volatile memory die 142 or while data is being programmed from the data latches 157 to the non-volatile memory array 142, the data buffer utilization module 112 may retry the data write (at 718).

In one implementation, the data buffer utilization module 112 may first check the data buffer management table 113 when a voltage detection error has occurred to see if the data in the local data buffer 117 is valid (at 720). If the data has not yet been overwritten and is thus valid, then the re-write of that data may be made directly from the local data buffer 117 rather than needing to return to the source data buffer outside of the NVM system 100, such as the host data buffer 218 or a shadow buffer 217, 417. If the write failure is detected after some or all of the data in the local data buffer 117 has already been overwritten (at 718, 720), then the data may be requested by again retrieving the data for the failed write from the source buffer outside of the NVM system 100, for example the host data buffer 218 or a shadow buffer 217, 417 (at 722). The steps of transferring the retrieved data portion, updating the data buffer management table 113, transferring the data from the local data buffer 117 to non-volatile memory 104 and releasing the local data buffer 117 may then be repeated (at 708-716).

If there was no programming failure detected (at 718) then the controller 102 determines whether there is more data for the command available in the source data buffer (for example the host data buffer 218) (at 724) and then retrieves that additional data (at 706) repeating the steps noted above. After retrieving all the remaining data using the process described, or if there is no more data for the same command remaining, the data buffer utilization module 112 may detect program and/or read verify status of the data written to the non-volatile memory 104 (at 726). As noted previously in the implementation of FIG. 6, the detection of a programming verification or read verification for data transferred to a non-volatile memory die 104 lags behind the overwriting of data in the local data buffer 117 such that the overwriting of the local data buffer 117 is asynchronous with the verification of a successful write of the prior data to the non-volatile memory array 14. The detection of the program verify status, and of one or more types of read verify status, may be accomplished in the same manner as described with reference to FIG. 6

When a program or read verification check, such the NAND verification or the ECC verification procedures noted above, indicates an error or other corruption, then the data buffer utilization module 112 may go back to the source data buffer and retrieve that data again and retry the write (at 728, 722). Unlike the method of FIG. 6, if there are no write failures detected via the program and read verification checks in place, then the controller determines if there are any more portions of data associated with the command (at 728, 730). If there are more portions of the command, then those portions are retrieved and processed as described above. If all the data for the command have now been written to the non-volatile memory array 142, then the controller 102 may send the host 212, 312 a message indicating a write success so that the host may then release the copy of that data still maintained in its buffer 218 (at 730, 732). In the method of FIG. 7, until all of the data for the given host command is successfully written into the non-volatile memory array 142 of the non-volatile memory 104, the controller delays sending any write success message to the host. Thus, simply by way of example, if a predetermined threshold amount of data required by the local data buffer (to completely fill the local data buffer and permit the controller to transfer data to the data latches) is 4 kilobytes (Kbytes) and the amount of data associated with a host cache command is 5 Kbytes, the controller 102 will wait until after it has written both the first 4 Kbytes of the data, and the second 1 Kbyte of the data for the same host cache command aggregated with 3 Kbytes of data from other commands, into non-volatile memory array 142 before sending the write success message.

While the implementation of FIG. 7 still includes the feature of releasing/overwriting the local data buffer in the NVM system before successfully writing to the non-volatile memory array as each portion of data is written into the data latches of the non-volatile memory, it also delays transmission of a write success message to the host relating to any portion of data associated with a particular host command until all the data for the particular host command has been successfully written, as determined by the one or more program and read verification determinations employed by the NVM system 100, such as those discussed above, into the non-volatile memory array 142 of the non-volatile memory 104.

In the present application, semiconductor memory devices such as those described in the present application may include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are exemplary, and memory elements may be otherwise configured.

The semiconductor memory elements located within and/or over a substrate may be arranged in two or three dimensions, such as a two dimensional memory structure or a three dimensional memory structure.

In a two dimensional memory structure, the semiconductor memory elements are arranged in a single plane or a single memory device level. Typically, in a two dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and word lines.

A three dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration, e.g., in an x-z plane, resulting in a three dimensional arrangement of memory elements with elements on multiple vertically stacked memory planes. Other configurations of memory elements in three dimensions can also constitute a three dimensional memory array.

By way of non-limiting example, in a three dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Then again, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this invention is not limited to the two dimensional and three dimensional exemplary structures described but cover all relevant memory structures within the spirit and scope of the invention as described herein and as understood by one of skill in the art.

A system and method for accelerated utilization of a data buffer in a non-volatile memory system has been described. Embodiments of the disclosed method and system may accelerate the data transfer from host to non-volatile memory system by optimal utilization of a data buffer in the non-volatile memory system configured to receive the next command data from the host without getting an acknowledgment that the write operation is successful for the previous command data.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the preferred embodiments described herein can be used alone or in combination with one another.

We claim:

1. A data storage system comprising:
a non-volatile memory having a plurality of data latches and a non-volatile memory array;
a volatile memory with a data buffer; and
a controller having, or cooperatively coupled with, the volatile memory and in communication with the non-volatile memory, wherein the controller is configured to:
request, from a host in communication with the data storage system, first data associated with a pending host command;
write to the data buffer in the volatile memory the first data received from the host;
copy the first data from the data buffer to the plurality of data latches;
request additional data from the host; and
write the additional data to the data buffer prior to verifying that the first data was successfully written from the plurality of latches to the non-volatile memory array, wherein writing the additional data overwrites at least some of the first data in the data buffer and wherein the verifying lags behind the overwriting.

2. The data storage system of claim 1, wherein the controller is configured to request the additional data from the host and overwrite at least some of the first data prior to sending a program command to the non-volatile memory to program the first data from the plurality of data latches into the non-volatile memory array.

3. The data storage system of claim 1, wherein the first data and the additional data are associated with a same host command.

4. The data storage system of claim 1, wherein the non-volatile memory comprises a silicon substrate and a plurality of memory cells forming a monolithic three-dimensional structure, wherein at least one portion of the memory cells is vertically disposed with respect to the silicon substrate.

5. The data storage system of claim 1, wherein the pending host command comprises a host write command.

6. The data storage system of claim 1, wherein the controller is further configured to, in response to receiving an indication of a write failure relating to the first data, re-request the first data from the host and, upon receipt of the re-requested first data at the data buffer, write the re-requested first data from the data buffer to the non-volatile memory.

7. The data storage system of claim 1, further comprising a data buffer management table in the controller, the data buffer management table containing information on data stored in the data buffer; and
wherein the controller is further configured to, in response to receiving an indication of a write failure relating to the first data:
determine from the data buffer management table whether the first data is valid in the data buffer; and
when the first data is determined to be valid in the data buffer, retry a write of the first data from the data buffer into the non-volatile memory.

8. The data storage system of claim 7, wherein the controller is further configured to, when the data buffer does not contain valid first data, re-request the first data from the host and, upon receipt of the re-requested first data at the data buffer, write the re-requested first data from the data buffer to the non-volatile memory.

9. The data storage system of claim 1, wherein the controller is further configured to: release the data buffer after copying the first data to the plurality of data latches and prior to verifying that the first data was successfully written to the non-volatile memory array.

10. The data storage system of claim 9, wherein to release the data buffer the controller is configured to update a data buffer management table in the controller to reflect that there is no valid data in the data buffer.

11. The data storage system of claim 9, wherein the controller is further configured to, in response to receiving an indication of a write failure relating to the first data, re-request the first data from the host and, upon receipt of the re-requested first data at the data buffer, write the first data from the data buffer to the non-volatile memory.

12. A method of managing data in a data storage system in communication with a host, the method comprising the storage system:
requesting data associated with a pending host command from a memory outside of the data storage system;
storing the data in a data buffer in volatile memory in the data storage system;
copying the data from the data buffer to non-volatile memory in the data storage system; and
prior to verifying that the data retrieved from the data buffer in the data storage system was successfully written to a non-volatile memory array in the non-volatile memory, requesting additional data from the host and overwriting at least some the data in the data buffer with the additional data.

13. The method of claim 12, wherein requesting data associated with the pending host command comprises requesting the data from a host data buffer on the host.

14. The method of claim 12, wherein requesting data associated with the pending host command comprises requesting the data from a data buffer positioned in a memory in a location other than the data storage system or the host.

15. The method of claim 12, further comprising, in response to receiving an indication of a write failure relating to the first data, re-requesting the first data from the memory and, upon receipt of the re-requested first data at the data buffer, writing the first data from the data buffer to the non-volatile memory.

16. The method of claim 15, wherein receiving the indication of a write failure comprises receiving an indication of a voltage detection error at the data storage system.

17. The method of claim 15, wherein receiving the indication of a write failure comprises receiving an indication of an error correction failure.

18. The method of claim 12, further comprising delaying transmission of any write success message to the host until all data associated with the pending host command has been verified as successfully written to the non-volatile memory array in the non-volatile memory.

19. A non-transitory computer readable medium comprising processor executable instructions that, when executed by a controller of a data storage system, cause the controller to:
request, from a memory in communication with the data storage system, first data associated with a pending host command;
in response to receipt of the first data from the memory, write the first data to a data buffer in a volatile memory in the data storage system;
retrieve the first data from the data buffer and transfer the first data to data latches in a non-volatile memory of the storage system; and
retrieve additional data from the memory and overwrite at least a portion of the first data in the data buffer prior to executing a program command to program the first data from the data latches into a non-volatile memory array in the non-volatile memory.

20. The non-transitory computer readable medium of claim 19, wherein the processor executable instructions to request the first data from the memory comprise instructions to request the first data from a host data buffer on the host.

21. The non-transitory computer readable medium of claim 19, wherein the processor executable instructions to request the first data from the memory comprise instructions to request the first data from an external data buffer in a location other than on the host or the data storage system.
